(19) United States
(12) Patent Application Publication
(10) Pub. No.: US 2008/0007384 A1
(43) Pub. Date: Jan. 10, 2008

(54) Variable Inductor

(76) Inventors: Yuejun Yan, Shenzhen (CN); Yuepeng Yan, Shenzhen (CN)

Correspondence Address: MATTHIAS SCHOLL, 14781 MEMORIAL DRIVE, SUITE 1319, HOUSTON, TX, 77079, US

(21) Appl. No.: 11/568,771

(22) PCT Filed: Feb. 17, 2005
(86) PCT No.: PCT/CN05/00197

§ 371 Date: Nov. 7, 2006

(30) Foreign Application Priority Data
May 10, 2004 (CN) 200410027166.9

(51) Int. Cl. H01F 21/04; H01F 27/28; H01F 5/00

(52) U.S. Cl. 336/206; 336/137; 336/200

(57) ABSTRACT

The present invention discloses a variable inductor for high frequency or microwave circuits, comprising a substrate, a fixed inductor, and signal terminals made of metal micro strip line disposed on the substrate, which also comprises a conductive sheet disposed on the substrate for changing the geometry of the metal micro strip line of the effective inductance portion of the fixed inductor, and an insulator for changing the contact area between the conductive sheet and the metal micro strip line of the fixed inductor, the insulator being adjacent to the conductive sheet. The variable inductor of the present invention is suitable for high frequency or microwave circuits. Its size is small, its cost is low, and it can be used for various circuits with adjusted inductance such as high frequency and microwave matching circuits, resonant circuits, control circuits, and so on.

### CROSS-REFERENCE TO RELATED APPLICATIONS

This is a National Stage Application of International Patent Application No. PCT/CN 2005/000197 with an international filing date of Feb. 17, 2005, which is based on Chinese Patent Application No. 200410027166.9, filed May 10, 2004. The contents of both of these specifications are incorporated herein by reference.

### BACKGROUND OF THE INVENTION

1. Field of the Invention

The present invention relates to variable inductors, and more particularly, to a variable inductor suitable for various high frequency or microwave circuits.

2. Description of Related Art

In the family of electronic devices, the existence of variable inductors makes the fabrication of electronic circuits more flexible and convenient. Variable inductors have been widely used in electronic circuits having operating frequencies below hundreds of megahertz (MHz), such as the matching circuit, the tuning circuit, and so on. However, conventional variable inductors are incapable of acting as inductors at high operating frequencies, their frequency characteristics are awful, and the value of the quality factor Q is extremely low. Therefore, conventional variable inductors cannot be used for electronic circuits having high operating frequencies.

### BRIEF SUMMARY OF THE INVENTION

The present invention arose in the context of the above problems, and it is one object of the present invention to provide a variable inductor suitable for various high frequency or microwave circuits.

To achieve the above objective, in accordance with one aspect of the present invention, there is provided a variable inductor suitable for various high frequency or microwave circuits comprising a substrate, a fixed inductor, and signal terminals made of metal micro strip line on the substrate, wherein said variable inductor also comprises a conductive sheet disposed on the substrate for changing the geometry of the metal micro strip line corresponding to the effective inductance portion of the fixed inductor, and an insulator for changing the contact area between the conductive sheet and the metal micro strip line of the fixed inductor, the insulator being adjacent to the conductive sheet.

As a result, the variable inductor of the present invention is realized by disposing a conductive sheet on the existing fixed inductor. With the assistance of an insulator, the conductive sheet is capable of changing the geometry of the metal micro strip line corresponding to the effective inductance portion of the fixed inductor, and thereby, the inductance of a variable inductor being varied continuously is realized.

The variable inductor of the present invention provides the following advantages:
a. it can be applied in high frequency or microwave bands to realize a variable inductance of an inductor;
b. its size is small, it is easy to be adjusted, and it is suitable for various miniaturized electronic and communication circuits;
c. its configuration is simple, its fabrication cost is low, and it is easy to be integrated into various circuits;
d. it is suitable for various tuning loops;
e. it is suitable for various matching loops;
f. it is suitable for various adjusting, controlling and stabilizing loops, such as for frequency stabilization, electromagnetic coupling adjustment, and so on;
g. it is suitable for the circuits where a highly precise inductance is required but a big variation of the fixed inductor exists such that sometimes the elements of the loop need to be adjusted to satisfy the characteristics of the entire circuit; and
h. it can be used in laboratories as adjusting or testing equipment for research and development.

### BRIEF DESCRIPTION OF THE DRAWINGS

FIG. 1 is a top plan view of a variable inductor in accordance with a first embodiment of the present invention;

FIG. 2 is a side elevational view of the variable inductor of the present invention shown in FIG. 1;

FIG. 3 is a top plan view showing a discontacted status between the conductive sheet of a variable inductor and the metal micro strip line of a fixed inductor shown in FIG. 1 of the present invention;

FIG. 4 is a top plan view of a partial contacted status between the conductive sheet of a variable inductor and the metal micro strip line of a fixed inductor shown in FIG. 1 of the present invention;

FIG. 5 is a top plan view of a variable inductor in accordance with a second embodiment of the present invention;

FIG. 6 is a cross-sectional view of the variable inductor of the present invention shown in FIG. 5;

FIG. 7 is a perspective view of a variable inductor in accordance with a third embodiment of the present invention;

FIG. 8 is a side elevational view of the variable inductor of the present invention shown in FIG. 7;

FIG. 9 is a top plan view of a partially-contacted status between the conductive sheet of a variable inductor and the metal micro strip line of a fixed inductor of the present invention shown in FIG. 7;

FIG. 10 is a cross-sectional view of a variable inductor in accordance with the third embodiment of the present invention;

FIG. 11 is a top plan view of a variable inductor in accordance with a fourth embodiment of the present invention;

FIG. 12 is a top plan view showing a partially-contact status between the conductive sheet of a variable inductor and the metal micro strip line of a fixed inductor of the present invention shown in FIG. 11;

FIG. 13 is a side elevational view of a variable inductor in accordance with a fifth embodiment of the present invention;

FIG. 14 is a top plan view showing a partially-contacted status between the conductive sheet of a variable inductor and the metal micro strip line of a fixed inductor of the present invention shown in FIG. 13;

FIG. 15 is a top plan view of a variable inductor in accordance with a sixth embodiment of the present invention;

FIG. 16 is a side elevational view of a variable inductor in accordance with a seventh embodiment of the present invention;

FIG. 17 is a top plan view showing a partially-contacted status between the conductive sheet of a variable inductor and the metal micro strip line of a fixed inductor of the present invention shown in FIG. 16;

FIG. 18 is a side elevational view of a variable inductor in accordance with an eighth embodiment of the present invention;

FIG. 19 is a perspective view of a metal micro strip line of a fixed inductor of a variable inductor in accordance with the present invention, wherein a portion of the metal micro strip line is embedded within the substrate and the other portion is exposed outside of the substrate;

FIG. 20 is a top plan view of a variable inductor in accordance with a ninth embodiment of the present invention; and

FIG. 21 is a top plan view of the variable inductor of the present invention shown in FIG. 20.

### DETAILED DESCRIPTION OF THE INVENTION

Preferred embodiments of the present invention will hereinafter be described in more detail with reference to the accompanying drawings.

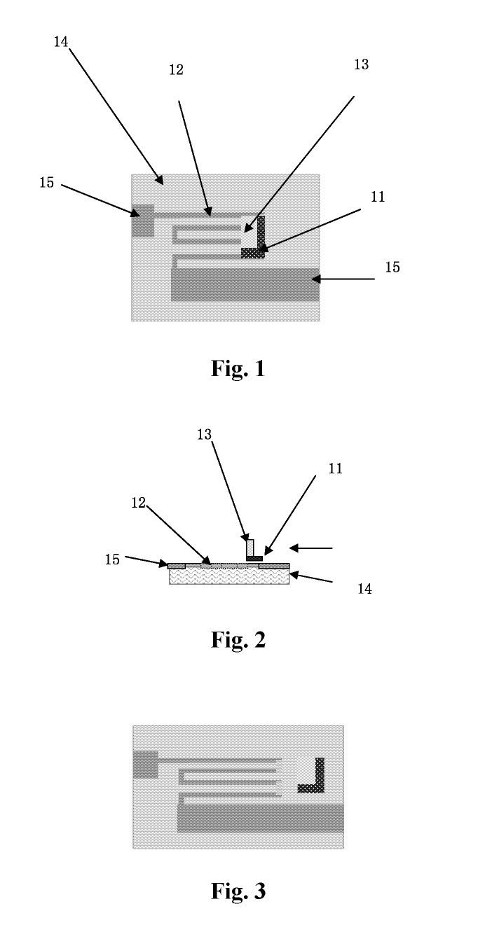

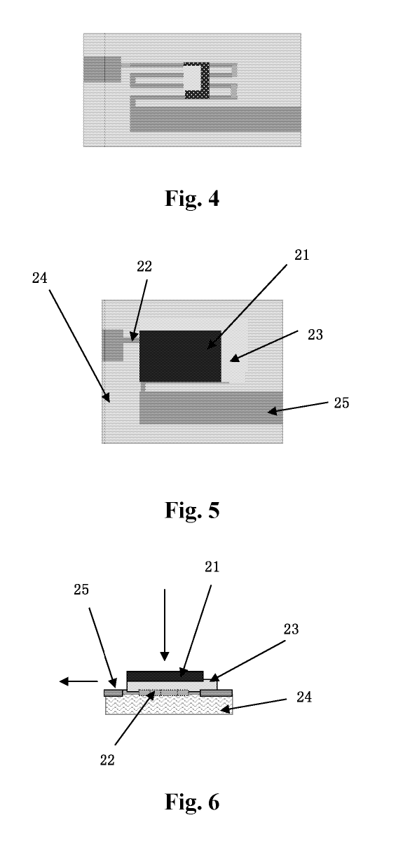

With reference to FIGS. 1 though 4, a variable inductor in accordance with a first embodiment of the present invention comprises a substrate 14, a fixed inductor 12 and signal terminals 15 made of metal micro strip line disposed on the substrate, a conductive sheet 11 for changing the length of the metal micro strip line of the effective inductance portion of the fixed inductor, and an insulator 13 for changing the position of the conductive sheet 11.

In the present embodiment, the conductive sheet 11 is disposed on the top surface of the substrate 14, the bottom surface of the conductive sheet 11 is contacted with the substrate 14, while the top surface is connected to the insulator 13. Changing the position of the insulator 13 along the direction of force, as illustrated in FIG. 2, changes the position of the conductive sheet 11 so as to contact the conductive sheet 11 with the fixed inductor 12, and to electrically short circuit a portion of or the entire metal micro strip line of the fixed inductor. As a consequence, the length of the metal micro strip line defining the effective inductance portion of the fixed inductor 12 is shortened. In this way, the inductance of the fixed inductor 12 is variably decreased so as to achieve the inductance of a variable inductor being varied continuously.

The fixed inductor 12 is a continuous parallel metal micro strip line, and the geometry and size of the conductive sheet 11 is capable of short-circuiting the metal micro strip line of the fixed inductor 12.

In order to ensure that the length of the metal micro strip line of the effective inductance portion of the fixed inductor 12 can be effectively changed, fixed blocks or splints (not shown) are installed at the both ends of the conductive sheet 11 so that the conductive sheet can be moved on a desired pathway. The insulator 13 can be fixed to the conductive sheet 11 by a gluing or a mechanical process in order to ensure the performance of repeatable movements.

In addition, the insulator 13 can also be disposed at the side of the conductive sheet 11.

With reference to FIGS. 5 and 6, the variable inductor in accordance with a second embodiment of the present invention varies from the variable inductor of the first embodiment in that an insulator 23 is disposed between a fixed inductor 22 and a conductive sheet 21. The configuration and geometry of the conductive sheet 21 should be applicable to shorten the length of the metal micro strip line of the effective inductance portion of the fixed inductor 22 when the fixed inductor 22 is insulated from the conductive sheet 21. By extracting the insulator 23 the fixed inductor 22 is contacted with the conductive sheet 21 so as to shorten the effective length of the metal micro strip line of the fixed inductor 22. In this way, the effective inductance of the fixed inductor 22 is decreased so as to achieve the inductance of a variable inductor being varied continuously. The insulator 23 can be an insulating sheet.

In order to ensure that the length of the metal micro strip line of the effective inductance portion of the fixed inductor 22 can be changed effectively, the insulator 23 can be extracted by rollers (not shown). One end of the insulator 23 is connected to one roller and the other end is connected to another roller by two insulating wires. By rotating one roller, the insulator 23 can be extracted gradually. When the roller at one end is being rotated, the insulator 23 is extracted, when the roller at the other end is being rotated in an opposite direction, the insulator 23 is drawn back in-between. Both the length and width of the insulator 23 can be greater than those of the conductive sheet 21, respectively. The gap between the two insulating wires can be greater than the width of the conductive sheet 21 to ensure that the conductive sheet 21 will not touch the insulating wires, and that the insulating wires clear at both ends the conductive sheet 21.

The top end of the conductive sheet 21 at the extracted end of the insulator 23 can be arranged at a small tilting angle so as to ensure that the insulator 23 can be drawn back conveniently.

Furthermore, an additional insulating layer can be disposed above the top surface of the conductive sheet 21, and a spring can be affixed to the top surface of the insulating layer the other end of the spring being affixed to an outer shell. Applying force onto the conductive sheet 21 through the spring ensures that the conductive sheet 21 is contacted effectively with the fixed inductor 22 when the insulator 23 is being extracted, and that the position of the conductive sheet 21 is kept unchanged. The conductive sheet 21, the insulating layer, and the spring can be combined through gluing or through a mechanical process.

In the variable inductor in accordance with the first and second embodiment of the present invention, the insulator is adjacent to the conductive sheet. With the assistance of the insulator, the contact area between the conductive sheet and the metal micro strip line of the fixed inductor can be changed. Therefore, the metal micro strip line of the fixed inductor is short circuited electrically, and thus the length of the metal micro strip line corresponding to effective inductance portion of the fixed inductor is shortened. In this way, the effective inductance of the fixed inductor is variably decreased so as to achieve the inductance of a variable inductor being varied continuously.

Furthermore, the impedances of the signal input and output terminals on the substrate can be designed to have a value such as 50 Ohm or 75 Ohm, as required. The width of the conductive sheet can be designed to be the same or similar to the width of the signal metal micro strip line.

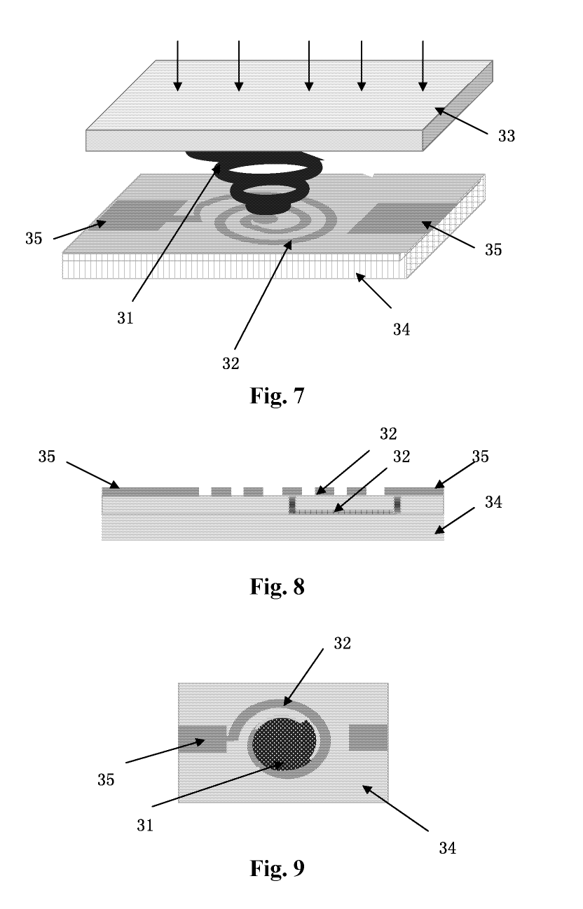

With reference to FIGS. 7 through 9, a variable inductor in accordance with a third embodiment of the present invention comprises a fixed inductor 32 made of circular spiral metal micro strip line disposed on a substrate 34 and having signal terminals 35, and a circular spiral pyramidal conductive sheet 31 made of circular spiral metal micro strip line for changing the length of the metal micro strip line of the effective inductance portion of the fixed inductor and an insulating forcing plate 33 for changing the geometry of the conductive sheet 31.

The substrate of the fixed inductor made of circular spiral metal micro strip line is configured with two layer substrate or multilayer substrates, wherein the connection between the central portion of the metal micro strip line of the fixed inductor and the signal output terminal is realized through the metal micro strip line of the middle layer substrate.

In the present embodiment, the conductive sheet 31 is disposed on the top surface of the substrate 34 and the top surface of the conductive sheet 31 is connected to the insulating forcing plate 33. By pressing the insulating forcing plate 33 along the direction of the force, as illustrated in FIG. 7, changes the geometry of the conductive sheet 31 so as to contact the conductive sheet 31 with the fixed inductor 32, and thereby to shorten the length of the metal micro strip line of the effective inductance portion of the fixed inductor 32. In this way, the inductance of the fixed inductor 32 can be decreased so as to achieve in effect the inductance of a variable inductor being varied continuously.

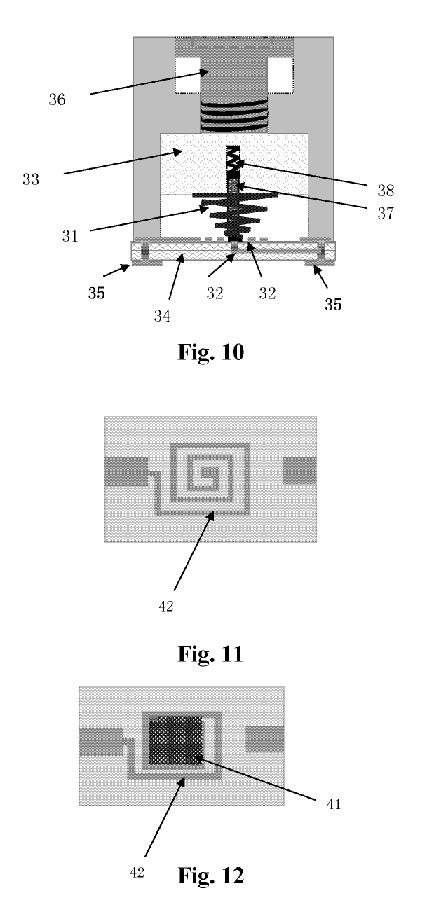

FIG. 10 is a cross-sectional view of the variable inductor in accordance with the third embodiment of the present invention. The substrate 34 of the fixed inductor made of circular spiral metal micro strip line is configured with two layers or multilayer substrates, wherein the connection between the central portion of the metal micro strip line on the surface of the substrate and the signal output terminal is realized through the metal micro strip line 32 of the middle layer of the substrate. When a press spiral screw 36 is being screwed in and out, the insulating forcing plate 33 will move down and up, respectively, the conductive sheet 31 will come into action, and the contact area between the conductive sheet 31 and the fixed inductor 32 will be changed. Thus the length of the metal micro strip line of the effective inductance portion of the fixed inductor will be changed, and thereby the inductance of the fixed inductor 32 will be changed so that a variable inductor is formed. Taking into consideration the wear of the conductive sheet due to its prolonged repeatable contact with the metal micro strip line of the fixed inductor and the fatigue of the conductive sheet, as well as the stability of the device, a positioning support rod 37 and an upside spring 38 can be added between the insulating forcing plate 33 and the substrate 34 so as to keep the center of the conductive sheet fixed from being varied, and to cushion and support the forcing plate when the forcing plate 33 is being pressed, as well as to prevent the circular spiral pyramidal conductive sheet from being subjected to excessive pressure. A spring with a low elastic coefficient and a high sensitivity is adopted for the circular spiral pyramidal conductive sheet, so that a low contact sensitivity resulting from the fatigue of the conductive sheet is avoided. Subsequently, the substrate 34 is combined with a frame 39. The impedances of the signal input and output terminals on the medium (or semiconductor wafer) substrate can be designed with a value such as 50 Ohm or 75 Ohm, as required.

With reference to FIGS. 11 and 12, the variable inductor in accordance with a fourth embodiment of the present invention varies from the variable inductor in accordance with the third embodiment in that the fixed inductor 42 is a tetragonal spiral metal micro strip line, and the conductive sheet 41 is a tetragonal spiral pyramidal conductive sheet. When the fixed inductor comes into contact with the conductive sheet, the fixed inductance L is kept unchanged. When the insulating forcing plate (not shown) is being pressed, the contact area between the fixed inductor 42 and the conductive sheet 41 increases, and thus the length of the metal micro strip line of the effective inductance portion of the fixed inductor 42 is changed, and the contact portion of the fixed inductor 42 and the conductive sheet loses its function as an inductor. Therefore, the inductance of the inductor decreases. As the insulating forcing plate is pressed so that the fixed inductor 42 is completely contacted with the conductive sheet 41, the contact area between the fixed inductor and the conductive sheet is maximal, the metal micro strip line of the fixed inductor will lose its function as an inductor, and the inductance decreases to zero. In the present embodiment, the fixed inductor 42 can also be a polygonal spiral metal micro strip line.

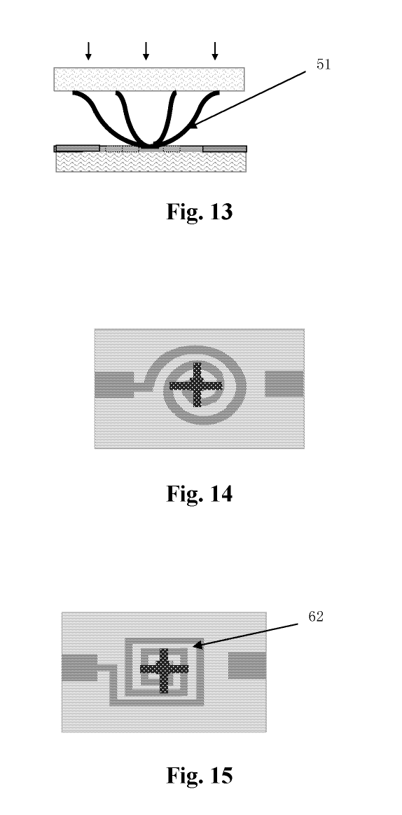

With reference to FIGS. 13 and 14, the variable inductor in accordance with a fifth embodiment of the present invention varies from the variable inductor in accordance with the third embodiment in that the conductive sheet 51 is a radial conductive spring sheet.

With reference to FIG. 15, the variable inductor in accordance with a sixth embodiment of the present invention varies from the variable inductor in accordance with the fifth embodiment in that the fixed inductor is a fixed inductor 62 made of tetragonal spiral metal micro strip line.

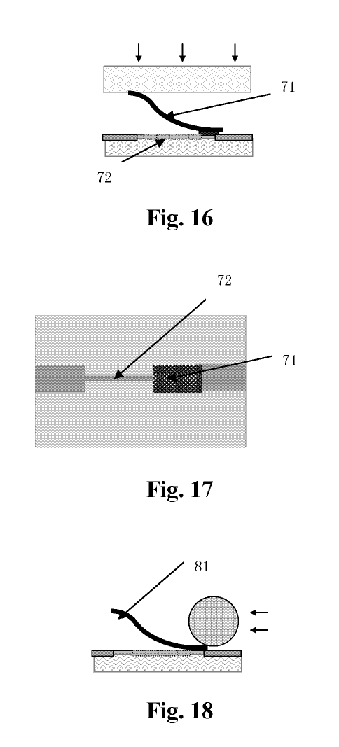

With reference to FIGS. 16 and 17, the variable inductor in accordance with a seventh embodiment of the present invention varies from the variable inductor in accordance with the third embodiment in that the conductive sheet 71 is a monolithic conductive spring sheet, and the fixed inductor is a fixed inductor 72 made of a single metal micro strip line. It is preferable that the cross-sectional width of the conductive sheet 71 is exactly the same as that of the signal metal micro strip line. When setting the position of the conductive sheet, it should be taken into consideration that the total width of the actual metal micro strip line should be the same as the width of the signal metal micro strip line when the conductive sheet is contacted with the metal micro strip line of the fixed inductor. The bottom surface of the conductive sheet should be smooth enough to ensure that an effective contact with the metal micro strip line is kept.

Furthermore, the insulator can be also disposed at the side of the conductive sheet 71.

With reference to FIG. 18, the variable inductor in accordance with a eighth embodiment of the present invention varies from the variable inductor in accordance with the seventh embodiment in that the conductive spring sheet 81 is side-forced.

Supposing that the inductance of the fixed inductor made of single metal micro strip line on the substrate is L, when the insulating forcing plate disposed at the top or side of the conductive sheet is being forced, the metal micro strip line of the fixed inductor will come into contact with the conductive sheet so as to shorten the length of the metal micro strip line corresponding to the effective inductance portion of the fixed inductor, and thereby to decrease the inductance of the inductor. When the force is increased to a certain extent so as to contact the conductive sheet with the metal micro strip line of the fixed inductor completely, the metal micro strip line of the fixed inductor is nearly changed into a single metal micro strip line and its characteristics as an inductor are totally lost, thus decreasing the inductance to zero.

The basic principle of a variable inductor in accordance with the third through the eighth embodiments of the present invention is that a conductive sheet is disposed on a fixed inductor made of metal micro strip line on a substrate. One side (or one end) of the conductive sheet can be contacted with the metal micro strip line of the fixed inductor, and the other side (or the other end) is fixed to an insulating forcing plate. It is preferable that the fabrication of the geometry and the setting of the position of the conductive sheet keep the conductive sheet contacted with the fixed inductor along the direction of the length of the metal micro strip line of the fixed inductor, and enable to change the length of the metal micro strip line corresponding to the effective inductance portion of the fixed inductor.

By placing a force on the insulating forcing plate above or at the side of the conductive sheet so as to realize the geometrical change of the conductive sheet along the direction of the length of the metal micro strip line of the fixed inductor and to increase the contact area between the conductive sheet and the metal micro strip line, and to widen the width of the contact portion of the metal micro strip line, the inductance of the metal micro strip line in the contact area can be decreased. With the increase of the force on the insulating forcing plate, the relatively widened portion of the metal micro strip line of the fixed inductor will be increased. In this way, the inductance of the fixed inductor will be decreased accordingly, and the inductance of the inductor being varied continuously is realized.

For the variable inductor in accordance with the embodiments of the present invention, the variable range of the inductance is ΔL=L˜0, where the L is the inductance of the fixed inductor formed on the substrate.

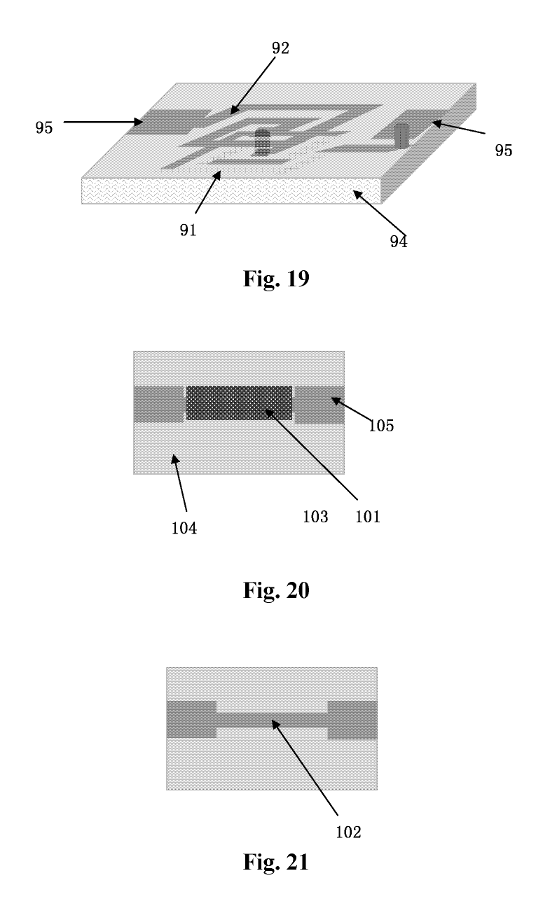

FIG. 19 is a structural view of metal micro strip line of a fixed inductor of a variable inductor in accordance with the present invention, where a portion 91 of the metal micro strip line is embedded within the substrate 94 and the other portion 92 is exposed outside of the substrate 94. Suppose that the inductance of the metal micro strip line within the substrate 94 is L(o), while that of outside of the substrate 94 is L(i), then the total inductance of the variable inductor of the present invention is L=L(i)+L(o). In this way, the variable range of inductance, ΔL=L(o)˜(L(i)+L(o)), of the inductor in accordance with the embodiments of the present invention is realized.

With reference to FIGS. 20 and 21, a variable inductor in accordance with the ninth embodiment of the present invention comprises a substrate 104, a fixed inductor 102 and signal terminals 105 made of metal micro strip line disposed on the substrate 104, a conductive sheet 101 for changing the width of metal micro strip line corresponding to the effective inductance portion of the fixed inductor, and an insulator 103 for changing the position of the conductive sheet 101, where the fixed inductor 102 is a single metal micro strip line.

The insulator 103 is disposed between the metal micro strip line of the fixed inductor 102 and the conductive sheet 101, the position and geometry of the conductive sheet 101 is applicable to widen the width of metal micro strip line corresponding to the effective inductance portion of the fixed inductor 102 when the fixed inductor 102 is insulated from the conductive sheet 101. By extracting the insulator 103, the metal micro strip line of the fixed inductor 102 can be contacted with the conductive sheet 101 so that the effective width of metal micro strip line of the fixed inductor 102 is widened. In this way, the effective inductance of the fixed inductor 102 is decreased, and effectively a continuously-variable inductor is realized.

The force applied on the insulator of the present invention can be a mechanical force; a manual force; an external force produced by an automatic control process; a mechanical force; an electromagnetic force; a force produced by heat or temperature variations; a force produced by flowing or expanding or contracting of a liquid; or a force initiated by an optoelectronic excitation process.

The variable inductor in accordance with the present invention is suitable for variable frequency resonance loops, load change, matching and impedance change loops, and various control loops of high frequency or microwave circuits.

1-17. (canceled)

18. A variable inductor comprising
a substrate having a top substrate surface;
a fixed inductor comprising an inductor micro stripline and two signal terminals being disposed on said substrate;
a conductive sheet being disposed on said substrate, having a bottom conductive sheet surface and a top conductive sheet surface, and forming a contact area with said inductor micro stripline; and
an insulator being adjacent to said conductive sheet;
wherein a movement of said insulator changes said contact area between said conductive sheet and said inductor micro stripline.

19. The variable inductor of claim 18, wherein
said conductive sheet is disposed on said top substrate surface;
said bottom conductive sheet surface is contacted with said substrate;
said top conductive sheet surface is connected to said insulator; and
applying an external force to said insulator changes the position of said conductive sheet with respect to said inductor micro stripline so as to change the effective inductance of the variable inductor.

20. The variable inductor of claim 18, wherein
said insulator is disposed between said fixed inductor and said conductive sheet; and
applying an external force to said insulator changes said contact area between said conductive sheet and said inductor micro stripline so as to change the effective inductance of the variable inductor.

21. The variable inductor of claim 18, wherein
said conductive sheet is elastic;
said conductive sheet is disposed on said top substrate surface;
said top conductive sheet surface is connected to said insulator; and
applying an external force to said insulator changes the position of said conductive sheet with respect to said inductor micro stripline so as to change the effective inductance of the variable inductor.

22. The variable inductor of claim 18, wherein
said conductive sheet is disposed on said top substrate surface;
said conductive sheet further comprises a side conductive sheet surface, said side conductive sheet surface being connected to said insulator; and
applying an external force to said insulator changes the position of said conductive sheet with respect to said inductor micro stripline so as to change the effective inductance of the variable inductor.

23. The variable inductor of claim 20, wherein the configuration and geometry of said conductive sheet allows for changing the length of the inductor micro stripline corresponding to the effective inductance portion of said fixed inductor.

24. The variable inductor of claim 20, wherein the configuration and geometry of said conductive sheet allows for changing the width of said inductor micro stripline corresponding to the effective inductance portion of the fixed inductor.

25. The variable inductor of claim 19, wherein
said inductor micro stripline is single-stranded or multiply stranded; and
said conductive sheet is monolithic or multilayer.

26. The variable inductor of claim 21, wherein
said inductor micro stripline is circularly-spiral or polygonally-spiral;
said conductive sheet is circularly-spirally-pyramidal or polygonally-spirally-pyramidal, and
said conductive sheet is concentric with said fixed inductor;
said substrate is multi-layered and has a middle layer substrate comprising a substrate micro stripline; and
said substrate micro stripline connects the center portion of said inductor micro stripline to one said signal terminal.

27. The variable inductor of claim 18, wherein said inductor micro stripline is partially embedded with said substrate.

28. The variable inductor of claim 20, wherein
said movement of said insulator is due to an external force, and
said external force is a mechanical force, an electromagnetic force, a force produced by heat or temperature variation, a force produced by flowing or expanding or contracting of a liquid, or a force produced by an optoelectronic excitation process.

29. The variable inductor of claim 20, wherein
said metal micro strip line is single-stranded or multiply stranded; and
said conductive sheet is monolithic or multilayer.

30. The variable inductor of claim 21, wherein
said metal micro strip line is single-stranded or multiply stranded; and
said conductive sheet is monolithic or multilayer.

31. The variable inductor of claim 22, wherein
said metal micro strip line is single-stranded or multiply stranded; and
said conductive sheet is monolithic or multilayer.

32. The variable inductor of claim 20, wherein
said movement of said insulator is due to an external force, and
said external force is a mechanical force, an electromagnetic force, a force produced by heat or temperature variation, a force produced by flowing or expanding or contracting of a liquid, or a force produced by an optoelectronic excitation process.

33. The variable inductor of claim 21, wherein
said movement of said insulator is due to an external force, and
said external force is a mechanical force, an electromagnetic force, a force produced by heat or temperature variation, a force produced by flowing or expanding or contracting of a liquid, or a force produced by an optoelectronic excitation process.

34. The variable inductor of claim 22, wherein
said movement of said insulator is due to an external force, and
said external force is a mechanical force, an electromagnetic force, a force produced by heat or temperature variation, a force produced by flowing or expanding or contracting of a liquid, or a force produced by an optoelectronic excitation process.
